(19) United States
(12) Patent Application Publication
(10) Pub. No.: US 2024/0198360 A1
(43) Pub. Date: Jun. 20, 2024

(54) MODULAR CENTRIFUGAL SEPARATOR SYSTEM AND COMPONENTS THEREOF

(71) Applicant: Alfa Laval Corporate AB, LUND (SE)

(72) Inventors: Kasper HÖGLUND, RÖNNINGE (SE); Anders EKSTRÖM, TÄBY (SE)

(73) Assignee: Alfa Laval Corporate AB, LUND (SE)

(21) Appl. No.: 18/286,447

(22) PCT Filed: Apr. 8, 2022
(86) PCT No.: PCT/EP2022/059485

§ 371 Date: Oct. 11, 2023

(30) Foreign Application Priority Data
May 3, 2021 (EP) 21171838.2

(51) Int. Cl. B04B 1/06; B04B 7/06; B04B 11/02

(52) U.S. Cl. CPC B04B 1/06; B04B 11/02; B04B 7/06

(57) ABSTRACT

A modular centrifugal separator system includes a base unit, an exchangeable separation insert arranged therein, an exchangeable tube kit, and an interface for fluid communication between the exchangeable separation insert and the exchangeable tube kit. The exchangeable separation insert includes a rotor casing forming a separation space, and a first half of the interface. The exchangeable tube kit includes at least one tube for one of the liquid feed mixture, the heavy phase, and the light phase, and a second half of the interface. The modular centrifugal separator system includes a removable sealing member covering the first and/or second half of the interface.

### TECHNICAL FIELD

The invention relates to a modular centrifugal separator system, an exchangeable separation insert, an exchangeable tube kit, and a kit of parts comprising an exchangeable separation insert and at least one exchangeable tube kit. The invention further relates to a method for assembling a modular centrifugal separator system.

### BACKGROUND

In the field of pharmaceuticals, biopharmaceuticals, biotechnology and thereto related fields, separation of substances from a liquid mixture such as, separation of cells from a cell culture mixture, are performed in a sterile environment. Traditionally, equipment made e.g., from stainless steel has been used, which equipment is sterilised between batches.

Lately, disposable separation equipment made for single use i.e., for one batch or a limited number of batches, has been suggested. For instance, US2011/0319248 discloses a single use centrifuge and WO 2015/181177 discloses a separator comprising an exchangeable inner drum.

Such disposable separation equipment is supplied to a user in a sterile manner. Thus, a sterile environment may be provided for the liquid mixture in the separator without sterilisation of the separation equipment at the production facility of the user.

### SUMMARY

In such prior art separation equipment made for single use, the exchangeable portion of the relevant separation equipment forms one entity with connections for fluid entering and leaving the separation equipment. The exchangeable portion is handled as one entity by a user of the separation equipment. Accordingly, the exchangeable portion is manufactured and delivered to the user as one entity.

It would be desirable to provide an alternative separator system configured for single use. In particular, it would be desirable to provide a versatile modular centrifugal separator system. To better address one or more of these concerns, one or more of a modular centrifugal separator system, an exchangeable separation insert, an exchangeable tube kit, a kit of parts, and a method for assembling a modular centrifugal separator system, having the features defined in one or more of the independent claims is/are provided.

According to an aspect of the invention, there is provided a modular centrifugal separator system configured for separating a liquid feed mixture into a heavy phase and light phase. The modular centrifugal separator system comprises a base unit and arranged therein an exchangeable separation insert, an exchangeable tube kit, and an interface for fluid communication between the exchangeable separation insert and the exchangeable tube kit. The exchangeable separation insert comprises a rotor casing forming a separation space, and a first half of the interface, the rotor casing being configured to rotate about a rotational axis extending in an axial direction. The exchangeable tube kit comprises at least one tube for one of the liquid feed mixture, the heavy phase, and the light phase, and a second half of the interface. The modular centrifugal separator system comprises a removable sealing member covering the first and/or second half of the interface.

Since the modular centrifugal separator system comprises the exchangeable separation insert and the exchangeable tube kit with the interface for fluid communication therebetween, and since the interface for fluid communication comprises the first and second halves with the removable sealing member covering at least one of the halves, the exchangeable separation insert comprising the rotor casing and the exchangeable tube kit comprising the at least one tube form separate components of the modular centrifugal separator system. Thus, the exchangeable separation insert and the exchangeable tube kit may be handled as separate units e.g., during mounting of them in the base unit. Accordingly, a versatile modular centrifugal separator system is provided.

Further, the complexity level of exchangeable parts of the modular centrifugal separator system may be reduced in comparison with exchangeable parts of the prior art systems comprising both rotating parts and tube connections as one entity. This may be advantageous inter alia from a manufacturing perspective. Also, providing the separation insert and the tube kit as separate units opens up possibilities for different suppliers providing the user with separation inserts on the one hand and tube kits on the other hand. This may provide further options related to supplier and logistics of exchangeable parts. Moreover, different kinds of exchangeable separation inserts and exchangeable tube kits may enable a user of the modular centrifugal separator system to provide different combinations of separation inserts and tube kits in the base unit e.g., depending on the requirements of a particular batch of liquid feed mixture. For instance, different kinds of tube kits configured for different flow rates may be combined with one and the same type of separation insert e.g., in order to provide separation at different flow rates during use of the modular centrifugal separator system.

The modular centrifugal separator system may be configured for use in the field of pharmaceuticals, biopharmaceuticals, biotechnology, and thereto related fields. In the modular centrifugal separator system, separation of substances from a liquid mixture such as separation of cells from a cell culture mixture, may be performed in a sterile environment.

In the modular centrifugal separator system, the liquid feed mixture is separated into a liquid heavy phase and liquid light phase. For instance, the liquid feed mixture may be formed by a cell culture mixture such as a fermentation broth including a cell culture. The light phase may be formed by fermentation broth without the cells or with only a minimum rest amount of cells and/or cell debris. The heavy phase may comprise the cells and cell debris suspended in fermentation broth.

The base unit is configured for repeated use with different exchangeable separation inserts and different exchangeable tube kits. That is, the base unit is reusable with new exchangeable parts such as the exchangeable separation insert and the exchangeable tube kit after one process batch or after a limited number of process batches.

The exchangeable separation insert and the exchangeable tube kit are configured for single use i.e., for separation of one batch only or a limited number of batches of liquid feed mixture.

Herein, the modular centrifugal separator system may also be referred to as separator system or system and the exchangeable separation insert may also be referred to as separation insert or insert. The exchangeable tube kit may also be referred to as tube kit.

The base unit comprises basic components for supporting the separation insert and the tube kit. The base unit is configured for rotating the rotor casing of the separation insert e.g., by supporting the separation insert in a rotatable member of the base unit. The rotatable member may be supported in a stationary frame of the base unit. Such a stationary frame may be stationary in the sense that it is stationary during use of the modular centrifugal separator system.

The separation insert may be configured to rotate in its entirety during use of the modular centrifugal separator system. Inside the separation space, there may be arranged a separation aid such as e.g., a stack of frustoconical separation.

The tube kit may be configured to be stationary during use of the modular centrifugal separator system. Accordingly, the interface for fluid communication may also form an interface between rotating and stationary parts of the modular centrifugal separator system.

The interface for fluid communication between the separation insert and the tube kit is an interface which, during use of the separator system, may provide one or more of sealed flow of the liquid feed mixture from the tube kit to the separation insert, sealed flow of the heavy phase from the separation insert to the tube kit, and sealed flow of the light phase from the separation insert to the tube kit.

During use of the modular centrifugal separator system the liquid feed mixture is separated into the light and heavy phases in the exchangeable separation insert. More specifically, as the rotor casing is rotated about its rotational axis, the gravitational field generated by the rotation will cause the liquid feed mixture in the separation space to separate into the light and heavy phases. That is, the exchangeable separation insert is that part of the modular centrifugal separator system wherein separation takes place during use of thereof.

During use of the modular centrifugal separator system, one or more liquids is/are conducted to and/or from the separation insert via the exchangeable tube kit. The liquids are one or more of the liquid feed mixture, the separated heavy phase, and the separated light phase. According to some embodiments, a further exchangeable tube kit may be provided. In such embodiments, one or more of the liquids is/are conducted to and/or from the separation insert via the further exchangeable tube kit.

Exchangeable parts of the modular centrifugal separator system such as, the exchangeable separation insert and the exchangeable tube kit may be configured to form the only part of the modular centrifugal separator system, which are in contact with one or more of the liquid feed mixture, the heavy phase, and light phase during use of the separator system.

According to some embodiments, the modular centrifugal separator system may comprise further exchangeable parts such as, a further exchangeable tube kit. In such case also the further exchangeable tube kit is configured to form one of the only parts which is in contact with one or more of the liquid feed mixture and the separated heavy and light phases during use of the separator system.

Each of the exchangeable separation insert, the exchangeable tube kit, and optional further exchangeable parts may be provided to a user as a sterile entity. That is, at least the insides of the separation insert, the tube kit, and the optional further exchangeable parts are sterile. Alternatively, two or more of the exchangeable separation insert, the exchangeable tube kit, and optional further exchangeable parts may be provided as a sterile kit of parts. Thus, when the exchangeable parts are assembled, the user will readily have available a centrifugal separator system with a sterile environment for separation of the liquid feed mixture.

In the base unit, different kinds of tube kits may be combined with different kinds of separation inserts e.g., in order to provide different separation properties, flow rates, and/or adapt the modular centrifugal separator system to different liquid feed mixtures.

The exchangeable separation insert and the exchangeable tube kit may be mounted in the base unit by the user. Prior to starting a separation operation in the modular centrifugal separator system, the removable sealing member is removed from the first and/or second halves of the interface e.g., by a user or in an automatic manner. Thus, the interface for fluid communication between the exchangeable separation insert and the exchangeable tube kit is opened up for fluid communication between the insert and the tube kit. The modular centrifugal separator system is set for separating the liquid feed mixture into the light and heavy phases and for conducting one or more of the liquid feed mixture and the separated light and heavy phases via the interface between the insert and the tube kit.

Herein, the terms mount and mounting of a part generally relates to installation of the relevant part in the base unit.

According to embodiments, the removable sealing member may be accessible for removal from the interface from outside the base unit. In this manner, the separation insert and the tube kit may be mounted in the base unit prior to removing the sealing member. Moreover, the separator system may be prepared for use thereof while the removable sealing member remains covering the first and/or second half of the interface as long as a user of the system may choose e.g., until just before separation of the liquid feed mixture is to commence.

According to embodiments, the removable sealing member may comprise a first sealing member portion covering the first half of the interface and a second sealing member portion covering the second half of the interface. In this manner, the insides of both the separation insert and the tube kit may be protected by the respective first and second sealing member portions in order to maintain the insides sterile. The separation insert and the tube kit may be handled as separate units by a user e.g., during mounting thereof in the base unit, while the insides may remain protected by the first and second sealing member portions.

According to embodiments, the first half of the interface may comprise a first sealing surface and the second half of the interface may comprise a second sealing surface. The first and second sealing surfaces may be configured to engage with each other when the removable sealing member has been removed. During use of the modular centrifugal separator system the first sealing surface may be rotatable about the rotational axis and the second sealing surface may be stationary. In this manner, there may be provided a fluid seal between the separation insert and the tube kit i.e., between the rotating and stationary parts of the separator system. The fluid seal may be provided for at least one of the liquid feed mixture, the light phase, and the heavy phase. Also, in this manner, the modular centrifugal separator system may be provided as a mechanically hermetically sealed separator system.

According to embodiments, the modular centrifugal separator system may comprise a securing member configured to establish an engagement between the exchangeable separation insert and the exchangeable tube kit, which engagement secures the exchangeable separation insert to the exchangeable tube kit for collective removal of the exchangeable separation insert and the exchangeable tube kit from the base unit. In this manner, the exchangeable separation insert and the exchangeable tube kit may be configured to be secured to each other, at or after mounting of the securing member in the base unit. Thus, the separation insert and the tube kit may be removed from the base unit as one entity after a separation operation has ended. Accordingly, leakage from the separation insert and/or the tube kit during removal of exchangeable parts from the separator system may be avoided.

The securing member may be mounted in the base unit after a separation operation has ended.

The engagement established by the securing member may provide for the exchangeable separation insert and the exchangeable tube kit to be removed as one single unit.

The securing member may convert the exchangeable separation insert and the exchangeable tube kit into a single removable, non-rotatable unit.

The securing member may destroy the interface between the exchangeable separation insert and the exchangeable tube kit. For instance, the sealing function and/or a relative rotational movement between the separation insert and the tube kit may be inhibited by the securing member. Thus, the separation insert and/or the tube kit may be rendered non-reusable. Hence, it may be ensured that used, and accordingly, non-sterile exchangeable separation inserts and exchangeable tube kits, are not put to use in the modular centrifugal separator system.

According to embodiments, the exchangeable tube kit and the interface may be arranged at a first axial end portion of the exchangeable separation insert. The modular centrifugal separator system may comprise a further exchangeable tube kit, and a further interface for fluid communication between the exchangeable separation insert and the further exchangeable tube kit. The further exchangeable tube kit and the further interface may be arranged at a second axial end portion of the exchangeable separation insert. The exchangeable separation insert may comprise a first half of the further interface. The further exchangeable tube kit may comprise a tube for at least one of the liquid feed mixture, the heavy phase, and the light phase, and a second half of the further interface. The modular centrifugal separator system may comprise a removable further sealing member covering the first and/or second half of the further interface. In this manner, fluid connections may be provided to the separation insert not only at its first axial end portion but also at its second axial end portion via the further exchangeable tube kit. Moreover, due to the removable further sealing member, the further exchangeable tube kit may be provided as a separate entity in a similar manner as the exchangeable tube kit arranged at the first axial end portion and may accordingly, provided the same or similar advantages.

According to a further aspect of the invention, there is provided an exchangeable separation insert for a modular centrifugal separator system configured for separating a liquid feed mixture into a heavy phase and light phase and comprising the exchangeable separation insert, a base unit, an exchangeable tube kit, and an interface for fluid communication between the exchangeable separation insert and the exchangeable tube kit. The exchangeable separation insert comprises a rotor casing which forms a separation space, and a first half of the interface, the rotor casing being configured to rotate about a rotational axis extending in an axial direction. The exchangeable separation insert comprises a first sealing member portion of a removable sealing member, the first sealing member portion covering the first half of the interface. The exchangeable separation insert forms a separate unit which is insertable into the base unit. In this manner, there is provided an exchangeable separation insert for a modular centrifugal separator system as discussed above.

Moreover, the exchangeable separation insert may be handled as a separate unit e.g., during mounting of it in the base unit, inter alia due to the first sealing member portion covering the first half of the interface which contributes to maintaining a sterile inside of the separation insert. Accordingly, the exchangeable separation insert contributes to a versatile modular centrifugal separator system.

According to a further aspect of the invention, there is provided an exchangeable tube kit for a modular centrifugal separator system configured for separating a liquid feed mixture into a heavy phase and light phase and comprising the exchangeable tube kit, a base unit, an exchangeable separation insert, and an interface for fluid communication between the exchangeable separation insert and the exchangeable tube kit, a first half the interface forming part of the exchangeable separation insert. The exchangeable tube kit comprises a tube for at least one of the liquid feed mixture, the heavy phase, and the light phase, a second half of the interface, and a sealing member portion of a removable sealing member covering the second half of the interface. The second half of the interface comprises a second sealing surface configured to engage with a first sealing surface of the exchangeable separation insert. During use of the modular centrifugal separator system the second sealing surface is configured to be stationary and engage with the rotating first sealing surface. The exchangeable tube kit forms a separate unit which is at least partially insertable into the base unit. In this manner, there is provided an exchangeable tube kit for a modular centrifugal separator system as discussed above, inter alia the tube kit comprises the second sealing surface configured to engage with the separation insert of the separator system.

Moreover, the exchangeable tube kit may be handled as a separate unit e.g., during mounting of it in the base unit, inter alia due to the sealing member portion covering the second half of the interface which contributes to maintaining a sterile inside of the tube kit. Accordingly, the exchangeable tube kit contributes to a versatile modular centrifugal separator system.

According to a further aspect of the invention, there is provided a kit of parts comprising an exchangeable separation insert according to any one of aspects and/or embodiments discussed herein and at least one exchangeable tube kit according to any one of aspects and/or embodiments discussed herein. In this manner, there are provided an exchangeable separation insert and an exchangeable tube kit for a modular centrifugal separator system as discussed above.

The exchangeable separation insert and the exchangeable tube kit of the kit of parts may be handled as separate units e.g., during mounting of them in the base unit, inter alia due to the sealing member portions covering the first and second halves of the interface which contributes to maintaining a sterile inside of the separation insert and the tube kit.

According to a further aspect of the invention, there is provided a method for assembling of a modular centrifugal separator system according to any one of aspects and/or embodiments discussed herein. The method comprises steps of:
mounting the exchangeable separation insert in the rotatable member of the base unit,
mounting the exchangeable tube kit in the base unit,
removing the sealing member from the first and/or second half of the interface. In this manner, the separator system may be assembled in a hygienic way preventing any contamination of the insides of the separation insert and the tube kit.

The order in which the steps of mounting the exchangeable separation insert and mounting the exchangeable tube kit are performed may be either first mounting the exchangeable separation insert or first mounting the exchangeable tube kit, depending on the layout of the modular centrifugal separator system and the base unit. If the separator system comprises more than one exchangeable tube kit, one tube kit may be mounted before the separation insert is mounted and one tube kit may be mounted after mounting the exchangeable separation insert.

The step of removing the sealing member is performed after the steps of mounting the exchangeable separation insert and mounting the exchangeable tube kit.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a-1d schematically illustrate embodiments a modular centrifugal separator system,

FIG. 2 schematically illustrates a cross section through a base unit of a modular centrifugal separator system,

FIGS. 3 and 4 schematically illustrates embodiments of an exchangeable separation insert, an exchangeable tube kit, and a further exchangeable tube kit,

FIG. 5 schematically illustrates a cross section through a portion of a modular centrifugal separator system according to embodiments,

FIG. 6 schematically illustrates embodiments of a removable sealing member, and

FIG. 7 illustrates a method for assembling of a modular centrifugal separator system.

### DETAILED DESCRIPTION

Aspects and/or embodiments of the invention will now be described more fully. Like numbers refer to like elements throughout. Well-known functions or constructions will not necessarily be described in detail for brevity and/or clarity.

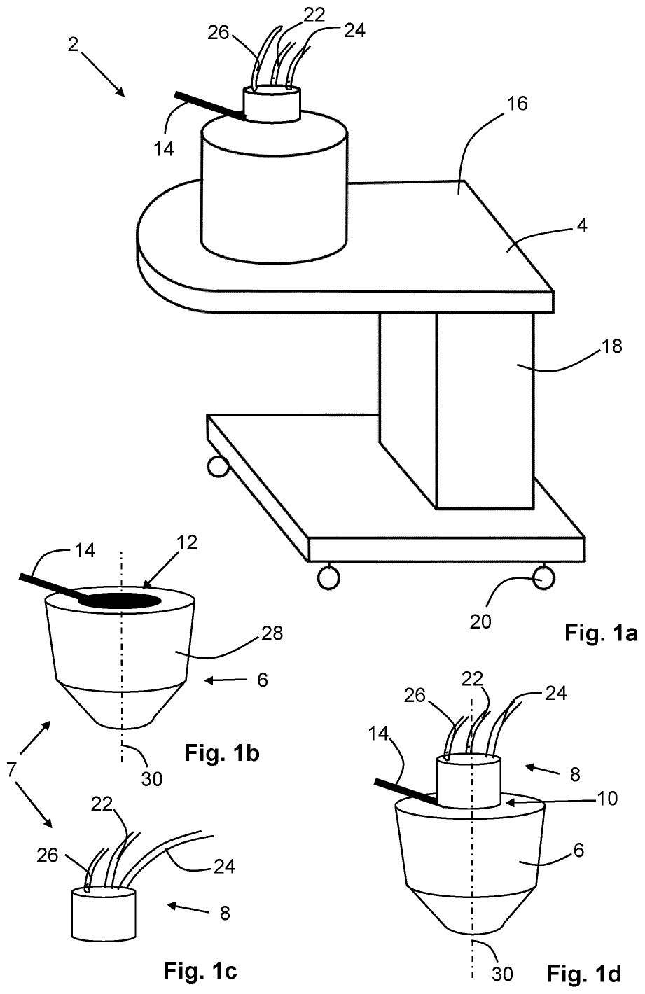

FIGS. 1a-1d schematically illustrate embodiments a modular centrifugal separator system 2. The modular centrifugal separator system 2 is configured for separating a liquid feed mixture into a heavy phase and light phase. The modular centrifugal separator system 2 may be configured for use in the field of pharmaceuticals, biopharmaceuticals, and/or biotechnology. For instance, the modular centrifugal separator system 2 may form part of a set-up in a plant for the production of cells such as, CHO cells (Chinese Hamster Ovary cells), or other matter resulting from processes in the biotech/pharma industry.

The modular centrifugal separator system 2 comprises a base unit 4, an exchangeable separation insert 6, and an exchangeable tube kit 8. In FIG. 1a, the modular centrifugal separator system 2 is shown in an assembled state i.e., with the separation insert 6 and the tube kit 8 mounted in the base unit 4. In FIG. 1b, the exchangeable separation insert 6 is shown. In FIG. 1c, the exchangeable tube kit 8 is shown. In FIG. 1d, the separation insert 6 and the tube kit 8 are shown adjacent to each other in a manner, in which they are arranged when mounted in the base unit 4.

The separator system 2 further comprises an interface 10 for fluid communication between the exchangeable separation insert 6 and the exchangeable tube kit 8. The separator system 2 also comprises a removable sealing member 12 covering at least a portion of the interface 10. The removable sealing member 12 prevents an interior of the separation insert 6 and/or an interior of the tube kit 8 from being contaminated during handling of the separation insert 6 and/or the tube kit 8 and/or during mounting of the separation insert 6 and/or the tube kit 8 in the base unit 4.

The exchangeable separation insert 8 and the exchangeable tube kit 8 are accordingly configured to be handled as separate units e.g., during mounting of them in the base unit.

The modular centrifugal separator system 2 is modular in the sense that it comprises the base unit 4, the exchangeable separation insert 6, and the exchangeable tube kit 8. The exchangeable separation insert 6 and the exchangeable tube kit 8 are exchanged for each new batch of liquid feed mixture, which is to be separated. Alternatively, the exchangeable separation insert 6 and the exchangeable tube kit 8 may be exchanged for each new type of liquid feed mixture, which is to be separated, i.e. one or more subsequent batches containing same type of liquid feed mixtures may be separated utilising the same separation insert 6 and tube kit 8.

During use of the modular centrifugal separator system 2 the liquid feed mixture, the heavy phase, and the light phase only come into contact with the insides of the separation insert 6 and the tube kit 8. The base unit 4 does not come into contact with the liquid feed mixture or any of the heavy and light phases.

The exchangeable separation insert 6 and the exchangeable tube kit 8 may be provided as a kit of parts 7 to a user of the modular centrifugal separator system 2. That is, the separation insert 6 as shown in FIG. 1b and the tube kit 8 as shown in FIG. 1c may be offered collectively to a user as unassembled separate parts, which thus, are provided for mounting in the base unit 4 one at a time.

The separation insert 6 comprises a rotor casing 28 forming a separation space, and a first half of the interface 10. The rotor casing 28 is configured to rotate about a rotational axis 30 extending in an axial direction.

The exchangeable tube kit 8 comprises at least one tube 22, 24, 26 for one of the liquid feed mixture, the heavy phase, and the light phase, and a second half of the interface 10.

In the illustrated embodiments, the tube kit 8 comprises all fluid connections for conducting fluid/liquid to and from the separator system 2. That is, the tube kit 8 comprises a first tube 22 for the liquid feed mixture, a second tube 24 for the separated heavy phase, and a third tube 26 for the separated light phase.

The tubes 22, 24, 26 may be configured for connecting the separator system 2 to other equipment external of the separator system 2 e.g., in a production facility of a user. Thus, the liquid feed mixture may be conducted from external equipment to the separator system 2 and the separated light and heavy phases from the separator system 2 to external equipment.

In these embodiments, as shown in FIG. 1d, in use of the separator system 2, the tube kit 8 is arranged above the separator insert 6.

According to alternative embodiments, the base unit 4 and the separator insert 6 may be configured for arranging the tube kit 8 below the separator insert 6 during use of the separator system 2.

According to further alternative embodiments, the separator system 2 may comprise a further tube kit. In such embodiments, one tube kit is arranged at each end of the separator insert 6 and the base unit 4 is configured for accommodating the two tube kits.

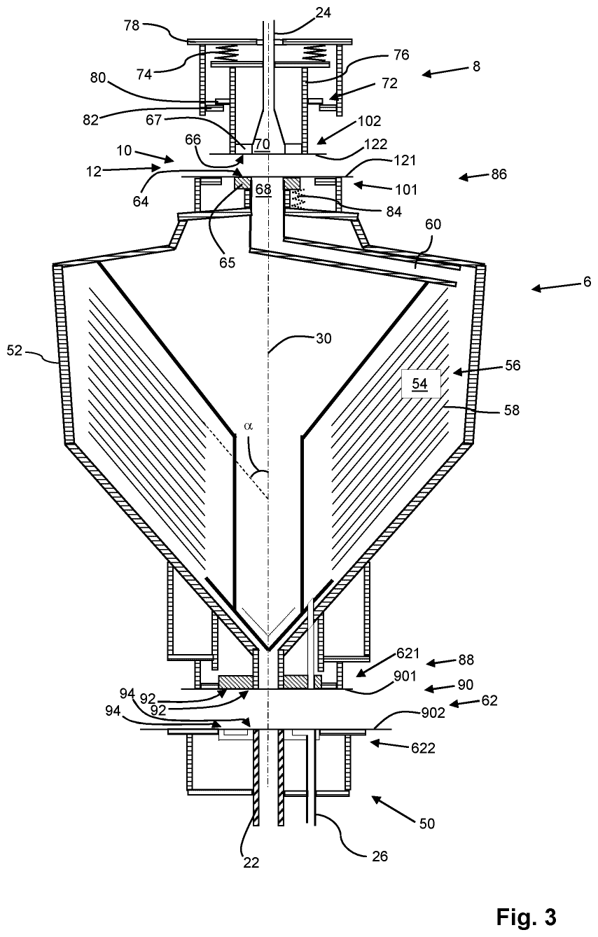

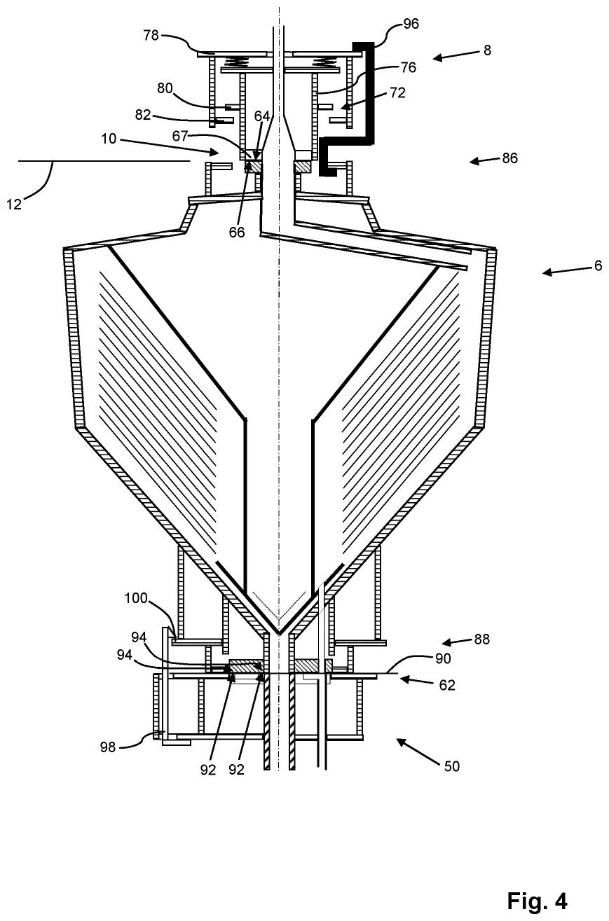

An exchangeable separation insert 6 is discussed in further detail below with reference to FIGS. 3 and 4. An exchangeable tube kit 8 is discussed in further detail below with reference to FIGS. 3 and 4.

The base unit 4 comprises components for supporting and rotating the exchangeable separation insert 6. The base unit 4 comprises components for supporting the exchangeable tube kit 8. Thus, the base unit 4 comprises inter alia a stationary frame 16, a rotatable member, and a drive unit for rotating the rotatable member. The stationary frame 16 may comprise a vertical member 18. Part of the drive unit may be arranged in the vertical member 18.

The stationary frame 16 is stationary during use of the modular centrifugal separator system 2. However, the base unit 4 as such may be movable, e.g. in order to be positioned at different locations at a production facility of the user. For this purpose, the stationary frame 16 may be provided with wheels 20.

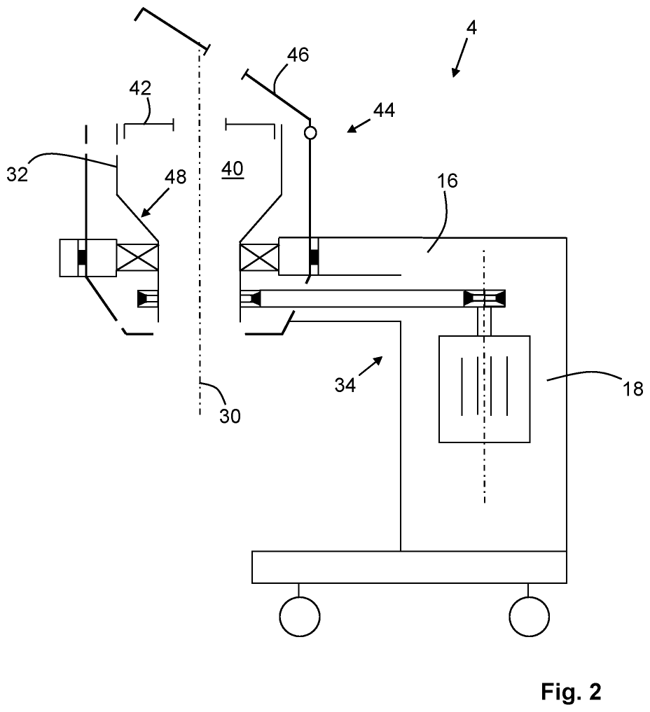

The base unit 4 is further discussed below with inter alia with reference to FIG. 2.

The interface 10 extends in a radial direction across the axial direction 30. In this manner, the interface 10 may be configured to form an interface between the stationary tube kit 8 and the rotatable separation insert 6. That is, the interface 10 and the radial direction extends perpendicularly to the axial direction 30.

The removable sealing member 12 covers the first and/or second half of the interface 10. In FIG. 1b, the removable sealing member 12 is shown covering the first half of the interface 10 i.e., the half of the interface 10 forming part of the separation insert 6. Also, the second half of the interface 10 i.e., the half of the interface forming part of the tube kit 8 may be covered by the removable sealing member 12 (not shown). Accordingly, the removable sealing member 12 may comprise two portions, one portion covering each half of the interface 10. Alternatively, the removable sealing member 12 covers only one half of the interface 10 such as, the first half of the interface 10. In such embodiments, for instance the tube kit 8 may be provided to the user in a sterile container such as, a sterile plastic bag. Namely, for some separation applications it is foreseeable that it may be sufficient to provide the removable sealing member 12 to seal only the separation insert 6 while it is handled and mounted in the base unit 4. The tube kit 8 on the other hand, may require much less handling and may be quickly fitted in the base unit 4, such that the short exposure of the tube kit 82 to the ambient environment from the opening of the sterile packaging until the tube kit 8 is mounted in the base unit 4, may not be detrimental to the fluids of the ensuing separation process.

The removable sealing member 12 may be accessible from an outside of the base unit 4. For instance, a pull tab or grasping portion 14 of the removable sealing member 12 may be accessible from an outside of the base unit 4. Thus, the removable sealing member 12 may be accessible for removal from the interface 10 from outside the base unit 4. The removable sealing member 12 has to be removed from the separator system 2 before separation of the liquid feed mixture is started.

FIG. 2 schematically illustrates a cross section through a base unit 4 of a modular centrifugal separator system. That is, in FIG. 2 an exchangeable separation insert and exchangeable tube kits of the separator system have been omitted.

The separator system resembles in much the separator system 2 of FIGS. 1a-1d. In the embodiments of FIG. 2, the base unit 4 is configured for use with one separation insert in conjunction with the two tube kits, as opposed to one tube kit only. However, the general concept of the base unit 4 illustrated in FIG. 2 may be used with a separation insert in conjunction with one tube kit only, at an upper end or a lower end of a rotatable member 32 of the base unit 4.

Again, as mentioned above, the base unit 4 comprises the stationary frame 16, the rotatable member 32, and the drive unit 34. In the illustrated embodiments, the drive unit 34 comprises an electric motor, a drive belt, and pullies arranged at the electric motor and the rotatable member 32. Alternative drive units may be used such as, an electric motor driving a transmission comprising gear wheels or a direct drive of the rotatable member provided by an electric motor.

The rotatable member 32 is arranged in the stationary frame 16 and is configured to rotate about a rotational axis 30. The drive unit 34 is configured for rotating the rotatable member 32 about the rotational axis 30.

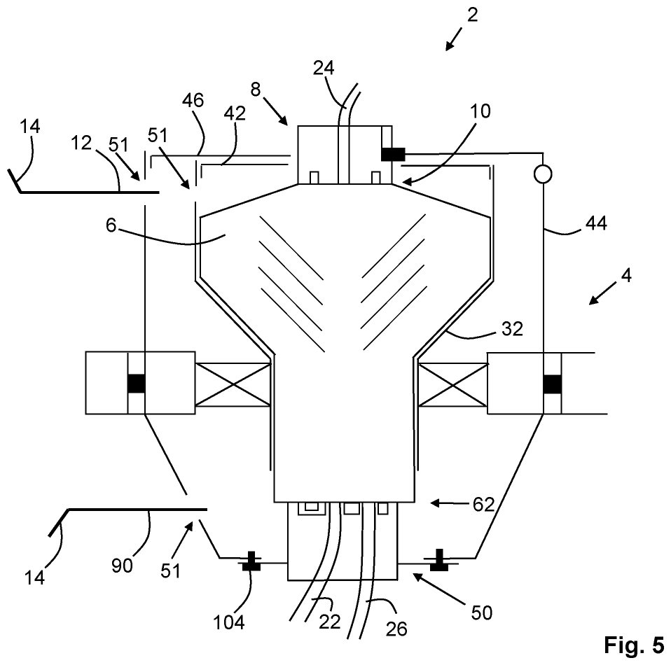

The rotatable member 32 delimits an inner space 40 at least in a radial direction. The radial direction extends perpendicularly to the rotational axis 30. The inner space 40 is configured for receiving at least part of an exchangeable separation insert therein, see further below with reference to FIG. 5. The rotational axis 30 coincides with that of a separation insert mounted in the rotatable member 32.

The base unit 4 is configured for receiving and holding a tube kit and a further tube kit. The two tube kits are held stationary in the base unit 4. There is provided an interface for fluid communication between each of the tube kits and the separation insert, when mounted in the base unit 4. See further below with reference to FIGS. 3-5.

The rotatable member 32 is open at both its axial ends. Accordingly, each of the two tube kits may interface with a separation insert arranged in the inner space 40. See further below with reference to FIGS. 3-5. According to alternative embodiments, the rotatable member 32 may be open at only one of its axial ends. Such embodiments may be used in the context of the separator system 2 discussed above with reference to FIGS. 1a-1d.

Access to the inner space 40 may be provided via a removable cap 42. Thus, an exchangeable separation insert may be mounted in and removed from the inner space 40 when the cap 42 has been removed from the rotatable member 32.

The rotatable member 32 is arranged inside a stationary housing 44. The housing 44 comprises a lid 46. In an open position of the lid 46, access is provided to the rotatable member 32 inside the housing 44 e.g., for exchange of a separation insert and one or more tube kits.

The inner space 40 of the rotatable member 32 is delimited at least in part by an inner surface 48. A separation insert to be mounted in the inner space 40 has an external shape to an extent that it fits inside the inner space 26. A separation insert, when fitted in the inner space 40, abuts against at least part of the inner surface 48. Thus, an exchangeable separation insert may be supported in the inner space 40 and entrained with the rotatable member 32 when it is rotated by the drive arrangement 34.

FIG. 3 schematically illustrates embodiments of an exchangeable separation insert 6, an exchangeable tube kit 8, and a further exchangeable tube kit 50. FIG. 3 illustrates a cross-section through the separation insert 6 and the tube kits 8, 50.

The exchangeable separation insert 6 is an exchangeable separation insert for a modular centrifugal separator system such as, the modular centrifugal separator system 2 discussed above in connection with FIGS. 1a-2 and below with reference to FIGS. 4-6. Accordingly, the exchangeable separation insert 6 may be configured for part of it to be arranged inside an inner space of a rotatable member of a base unit as discussed in connection with FIGS. 2 and 5.

Each of the exchangeable tube kits 8, 50 is an exchangeable tube kit for a modular centrifugal separator system such as, the modular centrifugal separator system 2 discussed above in connection with FIG. 2 and below with reference to FIGS. 4 and 5. Accordingly, each of the tube kits 8, 50 may be configured to be arranged in a base unit as discussed in connection with FIGS. 2 and 5.

The exchangeable separation insert 6 comprises a rotor casing 52. The rotor casing 50 delimits a separation space 54 therein. The rotor casing 50 is configured to rotate about a rotational axis 30 extending in an axial direction.

The exchangeable separation insert 6 comprises a separation aid arranged in the separation space 54. In the illustrated embodiments the separation aid comprises a stack 56 of frustoconical separation discs 58. The stack 56 may comprise at least 50 separation discs 58 such as, at least 100 separation discs 58 such as, at least 150 separation discs 58. Mentioned as an example, a separation disc 58 may have an outer diameter within a range of 160-400 mm, an inner diameter within a range of 60-100 mm, and an angle α between the rotational axis 30 and an inner surface of the disc 58 within a range of 35-40 degrees. For clarity reasons, only a few of the discs 58 are shown in FIG. 3.

When mounted in the base unit of the separator system, the separation insert 6 is arranged between the tube kit 8 and the further tube kit 50. That is, each of the tube kits 8, 50 is arranged at one axial end portion of the separation insert 6. The tube kits 8, 50 and the separation insert 6 will be arranged adjacent and in abutment with each other, see further below with reference to FIGS. 4 and 5. In FIG. 3, the tube kits 8, 50 and the separation insert 6 are illustrated separate from each other in a manner as they may appear prior to being mounted in the base unit.

Generally speaking, fluid connections to and from the separation insert 6 must be provided for the liquid feed mixture, the heavy phase, and the light phase. Such fluid connections are provided for by tube kits. As mentioned above, the exchangeable tube kit 8 comprises at least one tube for one of the liquid feed mixture, the heavy phase, and the light phase. In embodiments where not all fluid connections are provided by the tube kit 8, they are provided by the further tube kit 50. According to such embodiments the further tube kit 50 comprises at least one tube for one of the liquid feed mixture, the heavy phase, and the light phase, that is/are not provided by the tube kit 8.

In the embodiments of FIG. 3, the tube kit 8 comprises only one tube, a tube 24 for conducting the separated heavy phase from the separation insert 6. The further tube kit 50 comprises two tubes, one tube 22 for conducting the feed mixture to the separation insert 6 and one tube 26 for conducting the separated light phase from the separation insert 6.

Briefly, during use of the separator system, the liquid feed mixture is conducted via the tube 22 for liquid feed mixture into the separation insert 6. The liquid feed mixture flows into the separation space 54. The separated light phase flows towards the rotational axis 30 and leaves the separation space 54 and the separation insert 6 via the tube 26 for light phase. The separated heavy phase flows towards the outer periphery of the separation space 54. From the outer periphery, the heavy phase is conducted towards the rotational axis 30 via one or more outlet conduits 60 in the separation insert 6. The one or more outlet conduits 60 extend from a radially outer portion of the separation space 54 towards the rotational axis 30. The separated heavy phase leaves the separation insert 6 via the tube 24 for the heavy phase.

During use of the centrifugal separator system, the separation insert 6 rotates in its entirety and the tube kit 8 and the further tube kit 50 are stationary.

When assembled in the base unit of the separator system, the separator system comprises an interface 10 for fluid communication between the exchangeable separation insert 6 and the exchangeable tube kit 50. Similarly, the separator system comprises a further interface 62 for fluid communication between the exchangeable separation insert 6 and the further exchangeable tube kit 50.

During use of the separator system, each of the interface 10 and the further interface 62 provides for fluid communication in a sealed manner between the separation insert 6 and the relevant tube kit 8, 50. That is, the passage for each of the liquid feed mixture, the heavy phase, and the light phase between the separation insert 6 and the relevant of the tube kits 8, 50 is sealed by sealing surfaces which mechanically engaged with each other.

An embodiment of a fluid sealing arrangement will now be discussed with reference to the interface 10 between the exchangeable separation insert 6 and the exchangeable tube kit 8. The separation insert 6 comprises a first half 101 of the interface 10 and the tube kit 8 comprises a second half 102 of the interface 10. The first half 101 of the interface 10 comprises a first sealing surface 64. The first sealing surface 64 extends perpendicularly to the rotational axis 30. The first sealing surface 64 is ring-shaped and arranged concentrically with the rotational axis 30. The first sealing surface 64 encircles a fluid outlet 68 for the heavy phase from the separation insert 6. The second half 102 of the interface 10 comprises a second sealing surface 66. The second sealing surface 66 extends perpendicularly to the rotational axis 30. The second sealing surface 66 is ring-shaped and arranged concentrically with the rotational axis 30. The second sealing surface 66 encircles a fluid inlet 70 for the heavy phase in the tube kit 8.

The first and second sealing surfaces 64, 66 may form surfaces of suitable sealing surface members, such as ring-shaped plastic and/or carbon members. That is, the first sealing surface 64 may be a surface of a first sealing surface member 65 and the second sealing surface 66 may be a surface of a second sealing surface member 67.

A coolant may be provided to the sealing surfaces 64, 66 in a known manner (not shown).

During use of the modular centrifugal separator system, the first and second sealing surfaces 64, 66 are configured to engage with each other and the first sealing surface 64 is rotatable about the rotational axis 30 and the second sealing surface 66 is stationary. Thus, there is provided a mechanical hermetical seal between the separation insert 6 and the tube kit 8. In the illustrated embodiments, the seal is provided for the heavy phase.

In a similar manner, utilising further ring-shaped sealing surfaces, sealing arrangements for further liquids may be provided in the interface 10 between the separation insert 6 and the tube kit 8 in embodiments wherein further fluid connections i.e., for the liquid feed mixture and/or light phase, are provided by the tube kit 8, such as in the embodiments of the FIGS. 1a-1d.

In order to provide a proper abutment between the first and second sealing surfaces 64, 66, when the separation insert 6 and the tube kit 8 are mounted in the base unit, the second sealing surface 66 may be biased in a direction towards the first sealing surface 64.

A sealing surface member 67 comprising the second sealing surface 66 is biased in a direction towards the first sealing surface 64, and the tube kit 8 comprises a restricting member 72 configured for restricting a movement of the sealing surface member 67 in the axial direction. In this manner, the tube kit 8 may be configured for biasing the second sealing surface 66 towards the separation insert 6 while due to the provision of the restricting member 72 being able to be handled as one unit i.e., without coming apart. Namely, the restricting member 72 prevents the sealing surface member 67 from being biased along the axial direction beyond an end position.

The first sealing surface 64 is fixed in relation to the axial direction of the exchangeable separation insert 6. In this manner, the first sealing surface 64 is provided as a counterpart to the second sealing surface 66 when the separation insert 6 is mounted in the base unit.

In the embodiments of FIG. 3, spring elements 74 are arranged to provide the biasing of the sealing surface member 67 in the axial direction towards the first sealing surface 64. The energy stored in the spring elements 74 biases the sealing surface member 67 into the end position. The spring elements 74 are arranged between a first element 76 comprising the sealing surface member 67 and a second element 78 configured to be engaged with the base unit in a fixed axial position when the tube kit 8 is mounted in the base unit. Thus, when the second element 78 is fixed in the axial position, the spring elements 74 bias the first element 76 and the sealing surface member 67 with the second sealing surface 66 towards, and as will be later explained against, the first sealing surface 64.

The restricting member 72 may comprise one or more first protruding elements 80 protruding from the first element 76 and one or more second protruding elements 82 protruding from the second element 78. The first and second protruding elements 80, 82 are aligned with each other. Thus, the biasing provided by the spring elements 74 will cause the first and second protruding elements 80, 82 to abut against each other, as shown in FIG. 3. In this manner the restricting member 72 restricts the movement of the sealing surface member 67 in the axial direction.

In FIG. 3 the sealing surface member 67 is shown in the end position. That is, when the tube kit 8 is separate from the base unit of the modular centrifugal separator system, due to the bias provided by the spring elements 74, the sealing surface member 67 is positioned in the end position in relation to the second element 78. On the other hand, when the tube kit 8 and the separation insert 6 are mounted in the base unit, as shown in FIG. 4, the sealing surface element 67 has been displaced from the end position against the bias provided by the spring elements 74.

However, the biasing of the sealing surface member 67 and the restricting member 72 may be provided in the tube kit 8 in any other suitable manner.

According to alternative embodiments, a proper abutment between the first and second sealing surfaces 64, 66, when the separation insert 6 and the tube kit 8 are mounted in the base unit, may instead be achieved by the first sealing surface 64 being biased in a direction towards the second sealing surface 66.

In such embodiments, the first sealing surface member 65 comprising the first sealing surface 64 is biased in a direction towards the second sealing surface 66, and the exchangeable separation insert 6 comprises a restricting member configured for restricting an axial movement of the first sealing surface member 65. For instance, the biasing may be provided by one or more spring elements 84 indicated with broken lines in FIG. 3.

In such embodiments, the second sealing surface 66 may be fixed in relation to the axial direction when the tube kit 8 is mounted in the base unit thus, omitting the spring elements 74 and the second element 78.

Again, the separator system comprises a removable sealing member 12.

The removable sealing member 12 comprises a first sealing member portion 121 covering the first half 101 of the interface 10 and a second sealing member portion 122 covering the second half 102 of the interface 10. Accordingly, the inside of the separation insert 6 is at least in part protected by the first sealing member portion 121. The inside of the tube kit 8 is at least in part protected by the second sealing member portion 122.

At the opposite end of the tube kit 8 i.e., at the end of the at least one tube 24, the at least one tube 24 may be sealed in order to maintain the inside of the tube kit 8 sterile. The term inside relates to that portion of the tube kit 8 which comes into contact with one or more of the liquid feed mixture, the heavy phase, and the light phase. Similarly, when the separation insert 6 has fluid connections at its axial end opposite to the tube kit 8, as in the illustrated embodiments, these fluid connections may also be sealed e.g., by a further removable sealing member 90 as discussed below, in order to maintain the inside of the separation insert 6 sterile. Again, the term inside relates to that portion of the separation insert which comes into contact with one or more of the liquid feed mixture, the heavy phase, and the light phase.

According to embodiments, the first sealing member portion 121 may comprise a first film member and the second sealing member portion 122 may comprise a second film member. In this manner, a thin protective cover may be provided by each of the first and second sealing member portions 121, 122. Such film members permit the tube kit 8 to be positioned adjacent to and in abutment with the separation insert 6. The tube kit 8 and of the separation insert 6 are thus, position in relation to each other along the rotation axis 30 substantially in the same positions as when the removable sealing member 12 has been removed for operating the separator system.

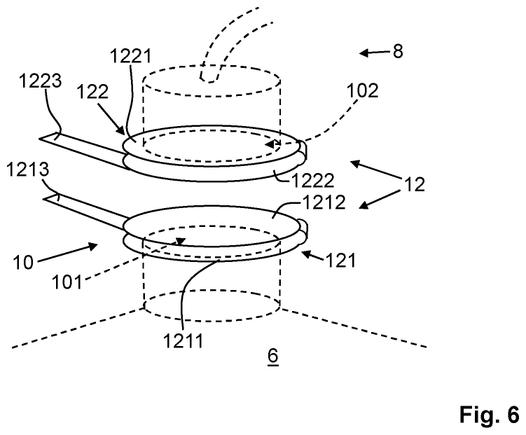

One embodiment of the removable sealing member 12 comprising first and second sealing member portions 121, 122 is discussed below with reference to FIG. 6.

During use of the modular centrifugal separator system, the first and second sealing surfaces 64, 66 are configured to engage with each other when the removable sealing member 12 has been removed.

The exchangeable tube kit 8 and the interface 10 are arranged at a first axial end portion 86 of the exchangeable separation insert 6. As mentioned above, the modular centrifugal separator system may comprise a further exchangeable tube kit 50, and a further interface 62 for fluid communication between the exchangeable separation insert 6 and the further exchangeable tube kit 50. The further exchangeable tube kit 50 and the further interface 62 are arranged at a second axial end portion 88 of the exchangeable separation insert 6. The exchangeable separation insert 6 comprises a first half 621 of the further interface 62. The further exchangeable tube kit 50 comprises a tube 22, 26 for at least one of the liquid feed mixture, the heavy phase, and the light phase, and a second half 622 of the further interface 62. The modular centrifugal separator system may comprise a removable further sealing member 90 covering the first and/or second half 621, 622 of the further interface 62.

As mentioned above, in the illustrated embodiments, the further tube kit 50 comprises a tube 22 for the liquid feed mixture and a tube 26 for the separated light phase.

Features and characteristics of the further exchangeable tube kit 50 and the further interface 62 may be provided in manners corresponding to, or similar to, those of the tube kit 8 and the interface 10. The main features and characteristics relating to:
The first and second halves 621, 622 of the further interface 62 comprises respective ring-shaped sealing surfaces 92, 94 separating the fluid connections or the liquid feed mixture and the light phase.
During use of the modular centrifugal separator system, the ring-shaped sealing surfaces 92, 94 are configured to engage with each other. The sealing surfaces 92 of the separation insert 6 are rotatable about the rotational axis 30 and the sealing surfaces 94 of the further tube kit 50 are stationary. Thus, there are provided mechanical hermetical seals between the separation insert 6 and the further tube kit 50.
Although a proper abutment between the sealing surfaces 92 of the separation insert 6 and the sealing surfaces 94 of the further tube kit 50 may be provided by other means, a proper abutment between the sealing surfaces 92, 94, when the separation insert 6 and the further tube kit 50 are mounted in the base unit, may be provided by the sealing surfaces 94 of the further tube kit 50 being biased in a direction towards the sealing surfaces 92 of the separation insert 6, or vice versa.
A restricting member (not shown) configured for restricting a movement of the sealing surfaces 94 of the further tube kit 50 in the axial direction caused by the biasing may be provided in a manner similar to that of the tube kit 8 at the first axial end portion 86.
Spring elements (not shown) may be arranged to provide the biasing of the sealing surfaces 94 of the further tube kit 50.
The further removable sealing member 90 comprises a first sealing member portion 901 covering the first half 621 of the further interface 62 and a second sealing member portion 902 covering the second half 622 of the further interface 62.
Each of the first and second sealing member portions 901, 902 of the further removable sealing member 90 may comprise a film member.
During use of the modular centrifugal separator system, the sealing surfaces 92, 94 of the separation insert 6 and the further tube kit 50 are configured to engage with each other when the further removable sealing member 90 has been removed.

FIG. 4 schematically illustrates a cross section through the exchangeable separation insert 6, tube kit 8, and further tube kit 50 of the embodiments of FIG. 3. In FIG. 4 the tube kit 8 and the further tube kit 50 are arranged adjacent to and in abutment with the separation insert 6 in a manner as they appear when being mounted in the base unit of a separator system. At the first axial end portion 86, at the interface 10 between the tube kit 8 and the separation insert 6, the removable sealing member 12 has been removed as for separation operation in the modular centrifugal separator system. At the second axial end portion 88, at the further interface 62 between the further tube kit 50 and the separation insert 6, the further removable sealing member 90 is still in place between the further tube kit 50 and the separation insert 6 and has to be removed for separation operation in the modular centrifugal separator system.

In FIG. 4 as in FIG. 3, the sealing surface member 67 comprising the second sealing surface 66 is biased in a direction towards the first sealing surface 64. However, in FIG. 4, the restricting member 72 does not restrict the movement of the sealing surface member 67 in the axial direction. Since the second element 78 is engaged with the base unit in a fixed axial position when the tube kit 8 is mounted in the base unit and since the first and second sealing surfaces 64, 66 abut against each other, the first and second elements 76, 78 are positioned in relation to each other such that the first and second protruding elements 80, 82 of the restricting member 72 are separated from each other.

In order to be able to handle the tube kit 8 and the separation insert 6 as one entity after a separation operation has ended, the centrifugal separator system comprises a securing member 96 configured to establish an engagement between the exchangeable separation insert 6 and the exchangeable tube kit 8. The engagement secures the exchangeable separation insert 6 to the exchangeable tube kit 8 for collective removal of the exchangeable separation insert 6 and the exchangeable tube kit 8 from the base unit.

Specifically, the securing member 96 may maintain the exchangeable separation insert 6 and the exchangeable tube kit 8 in a position in relation to each other such that the first and second sealing surfaces 64, 66 remain engaged with each other during the collective removal of the exchangeable separation insert 6 and the exchangeable tube kit 8 from the base unit.

Similarly, the centrifugal separator system may comprise a further securing member 98 configured to establish an engagement between the exchangeable separation insert 6 and the further exchangeable tube kit 50. The engagement secures the exchangeable separation insert 6 to the further exchangeable tube kit 50 for collective removal of the exchangeable separation insert 6 and the further exchangeable tube kit 50 from the base unit.

The further securing member 98 may maintain the exchangeable separation insert 6 and the further tube kit 50 in a position in relation to each other such that the sealing surfaces 92, 94 between the separation insert 6 and the further tube kit 50 remain engaged with each other during the collective removal of the separation insert 6 and the further tube kit 50 from the base unit.

Thus, the securing member 96 and the further securing member 98 may have one of a number of different conceivable configurations. Exemplified in the illustrated embodiments is am S-shaped hook 96 which engages in a recess of the separation insert 6 and around an axial end of the tube kit 8 and a snap-fit mechanism 98 extending through the further tube kit 50 to engage with a protrusion 100 of the separation insert 6 and abutting against an axial end surface of the further tube kit 50. Other alternative securing members 96 and further securing members 98 may comprise one or more screws for screwing the tube kit 8 and/or the further tube kit 50 to the separation insert 6, a hook and loop fastener, a clamping mechanism, etc.

The securing member 96 and/or the further securing member 98 may secure the separation insert 6 to the tube kit 8 and/or to the further tube kit 50 at mounting of them in the base unit. Alternatively, the securing member 96 and/or the further securing member 98 may secure the separation insert 6 to the tube kit 8 and/or to the further tube kit 50 after them being mounted in the base unit, either before separation starts or after separation has ended.

According to some embodiments, in order to make the separation insert 6 and/or the tube kit 8 non-reusable, the securing member and/or the further securing member may destroy the interface 10 between the separation insert 6 and the tube kit 8 and/or the further interface 62 between the further tube kit 50 and the separation insert 6. For instance, the securing member may damage the first and second sealing surfaces 64, 66 and the further securing member may damage the sealing surfaces 92, 94 of the separation insert 6 and the further tube kit 50.

FIG. 5 schematically illustrates a cross section through a portion of a modular centrifugal separator system 2 according to embodiments. The centrifugal separator system 2 may be a separator system 2 as discussed above with reference to FIGS. 2-4 i.e., comprising a base unit 4 and mounted therein an exchangeable separation insert 6, an exchangeable tube kit 8, and a further exchangeable tube kit 50. In FIG. 5, the drive unit of the base unit 4 has been omitted for the sake of clarity.

The separation insert 6 is mounted in the rotatable member 32 of the base unit 4. The tube kit 8 is mounted in the base unit 4 in abutment with the separation insert 6 at the interface 10. A portion of the tube kit 8 extends through the cap 42 and the lid 46 of the housing 44. Thus, the tube 24 of the tube kit 8 is accessible for connection e.g., to equipment external to the separator system 2. The further tube kit 50 is mounted in the base unit 4 in abutment with the separation insert 6 at the further interface 90. The tubes 22, 26 of the further tube kit 50 are accessible for connection e.g., to equipment external to the separator system 2.

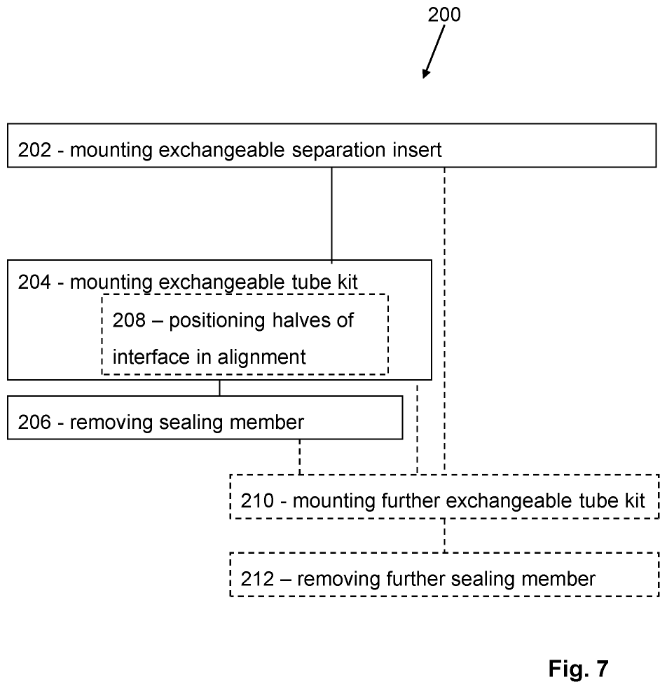

Mounting of the separation insert 6, the tube kit 8, and the further tube kit 50 in the base unit 4 may be performed in accordance with the method 200 discussed below with reference to FIG. 7.

In order to place the separation insert 6 inside the rotatable member 32, the lid 46 is opened and the cap 42 is removed. Thereafter, the tube kit 8 is positioned in abutment with the separation insert 6. The cap 46 is repositioned at the rotatable member 32 and the lid 46 is closed. The tube kit 8 is held in an axial position e.g., by the lid 46, such that a proper function of the interface 10 is established. The further tube kit 50 is positioned in abutment with the separation insert 6 from below the separation insert 6. The further tube kit 50 is secured to the base unit 4 with e.g., screws 104, clamps or other suitable devices. The further tube kit 50 is held in an axial position such that a proper function of the further interface 62 is established.

In FIG. 5, the separator system 2 is shown ready to be used for a separation operation. Accordingly, the removable sealing member 12 and the further removable sealing member 90 have been removed from the interface 10 and the further interface 62. Each of the removable sealing member 12 and the further removable sealing member 90 was provided accessible from an outside of the base unit and 4 e.g., via a pull tab or grasping portion 14 extending through a slit 51 in the housing 44 and also in the rotatable member 32 for the removable sealing member 12.

FIG. 6 schematically illustrates embodiments of a removable sealing member 12. The removable sealing member 12 is discussed with reference to an interface 10 between a tube kit 8 and a separation insert 6 e.g., as discussed above with reference to FIGS. 1a-5. The further removable sealing member 90 of the further interface 62 discussed above with reference to FIGS. 3-5 may be of the same kind.

In FIG. 6, the tube kit 8 and the separation insert 6 have been indicated with broken lines to clearly show the removable sealing member 12.

The removable sealing member 12 comprises a first sealing member portion 121 covering the first half 101 of the interface 10 and a second sealing member portion 122 covering the second half 102 of the interface 10.

The removable sealing member 12 is shown with the first and second sealing member portions 121, 122 separated, prior to the tube kit 8 being positioned adjacent to the separation insert 6.

The first sealing member portion 121 comprises a first film member 121 and the second sealing member portion 122 comprises a second film member 122.

The first film member 121 comprises an attachment portion 1211 releasably connected to a first half 101 of the interface 10, a folded portion 1212 connected to the attachment portion 1211, and a grasping portion 1213 connected to the folded portion 1212. The folded portion 1212 is connected to the attachment portion 1211 diametrically opposite to the grasping portion 1213. At least a portion of the folded portion 1212 abuts against the attachment portion 1211 and the grasping portion 1213 extends beyond the interface 10. In this manner, the first film member 121 is configured to be easily peelable from the first half 101 of the interface 10 also when the tube kit 8 is arranged in abutment with the separation insert 6.

In FIG. 6, the different portions 1211, 1212, 1213 or shown separated from each other for the sake of clarity. In practice, the folded portion 1212 is folded over the attachment portion 1211 and abuts thereagainst.

A user pulling at the grasping portion 1213 will pull the folded portion 1212 out of the interface 10. Since the grasping portion 1213 is connected to the folded portion 1212 opposite to the connection between the folded portion 1212 and the attachment portion 1211, the attachment portion 1211 will be peeled off the first half 101 of the interface 10 as the user pulls at the grasping portion 1213.

Similarly, the second film member 122 may comprise an attachment portion 1221 releasably connected to a second half 102 of the interface 10, a folded portion 1222 connected to the attachment portion 1221, and a grasping portion 1223 connected to the folded portion 1222. The folded portion 1222 of the second film member 122 is connected to the attachment portion 1221 of the second film member 122 diametrically opposite to the grasping portion 1223 of the second film member 122. At least a portion of the folded portion 1222 of the second film member 122 abuts against the attachment portion 1221 of the second film member 122 and the grasping portion 1223 of the second film member 122 extends beyond the interface 10.

Thus, also the second film member 122 may be configured to be easily peelable from the second half 102 of the interface 10 in a similar manner to the first film member 121 being easily peelable from the first half 101 of the interface 10.

When the tube kit 8 is arranged in abutment with the separation insert 6 the respective grasping portions 1213, 1223 of the first and second film members 121, 122 may be grasped and pulled at simultaneously to remove the entire sealing member 12 from the interface 10.

The removable sealing member 12 may be accessible for removal from the interface 10 from outside the base unit of the separator system. For instance, the two grasping portions 1213, 1223 may be accessible outside the base unit. A slit may be provided in the base unit through which the grasping portions 1213, 1223 may extend from inside the base unit to outside thereof.

The first and second film members 121, 122 may be made from BoPET (biaxially-oriented polyethylene terephthalate), inter alia sold under the name Mylar.

In the following discussion reference is made to FIGS. 1a-6. The exchangeable separation insert 6 may be provided as a separate sterile unit configured for single use. Accordingly, one aspect of the invention relates to an exchangeable separation insert 6 for a modular centrifugal separator system 2 configured for separating a liquid feed mixture into a heavy phase and light phase as discussed herein. The separator system 2 comprises the exchangeable separation insert 6, a base unit 4, an exchangeable tube kit 8, and an interface 10 for fluid communication between the exchangeable separation insert 6 and the exchangeable tube kit 6.

The exchangeable separation insert 6 comprises a rotor casing 52 forming a separation space 54, and a first half 101 of the interface 10. The rotor casing 52 is configured to rotate about a rotational axis 30 extending in an axial direction. The exchangeable separation insert 6 comprises a first sealing member portion 121 of a removable sealing member 12. The first sealing member portion 121 covers the first half 101 of the interface 10. The exchangeable separation insert 6 forms a separate unit which is insertable into the base unit 4. Since the first half 101 of the interface 10 is covered by the first sealing member portion 121, an inside of the separation insert 6 is protected from the ambient environment. Accordingly, the separation insert 6 may be handled as a sterile unit.

According to embodiments, the first half 101 of the interface 10 may comprise a first sealing surface 64 and the first sealing member portion 121 may cover the first sealing surface 64. In this manner, the first sealing member portion 121 may protect the first sealing surface 64.

After removal of the first sealing member portion 121, when preparing the separation insert 6 for a separation operation, the first sealing surface 64 may engage with a corresponding sealing surface of the tube kit 8.

According to embodiments, the exchangeable separation insert 6 may comprise, with the exception of the first sealing member portion 121, only parts which are rotated about the rotational axis 30 during use of the modular centrifugal separator system 2.

Obviously, the first sealing member portion 121 is removed prior to starting a separation operation. Accordingly, during use of the separator system 2, the exchangeable separation insert 6 comprises only rotatable parts. The tube kit 8, and if present the further tube kit 50, form/s exchangeable stationary parts of the separator system 2.

According to embodiments, the first sealing member portion 121 may comprise a first film member 121, an attachment portion 1211 of which is releasably connected to the first half 101 of the interface 10. In this manner, there may be provided a first sealing member portion 121 configured for sealing the first half 101 of the interface 10 and for removal therefrom.

According to embodiments, the separator system 2 may comprise a further interface 62 for fluid communication between the exchangeable separation insert 6 and a further exchangeable tube kit 50.

In such embodiments, the interface 10 is arranged at a first axial end portion 86 of the exchangeable separation insert 6 and the further interface 62 is arranged at a second axial end portion 88 of the exchangeable separation insert 6. The exchangeable separation insert 6 comprises a first half 621 of the further interface 62. The exchangeable separation insert 6 comprises a first sealing member portion 901 of a further removable sealing member 12. The first sealing member portion 901 of the further removable sealing member 12 covers the first half 621 of the further interface 62.

Similar to the first sealing member portion 121, the first sealing member portion 901 of the further removable sealing member 12, may comprise a film member 122, an attachment portion 1221 of which is releasably connected to the first half 621 of the further interface 62. Thus, there may be provided a first sealing member portion 901 of the further removable sealing member 12 configured for sealing the first half 621 of the further interface 62 and for removal therefrom.

The exchangeable separation insert 6 may comprise further features as discussed above with reference to FIGS. 1a-6.

In the following discussion reference is made to FIGS. 1a-6. The exchangeable tube kit 8 may be provided as a separate sterile unit configured for single use. Accordingly, one aspect of the invention relates to an exchangeable tube kit 8 for a modular centrifugal separator system 2 configured for separating a liquid feed mixture into a heavy phase and light phase. The separator system 2 comprises the exchangeable tube kit 8, a base unit 4, an exchangeable separation insert 6, and an interface 10 for fluid communication between the exchangeable separation insert 6 and the exchangeable tube kit 8. A first half 101 the interface 10 forms part of the exchangeable separation insert 6.

The exchangeable tube kit 8 comprises a tube 22, 24, 26 for at least one of the liquid feed mixture, the heavy phase, and the light phase, a second half 102 of the interface 10, and a sealing member portion 122 of a removable sealing member 12 covering the second half 102 of the interface 10. The second half 102 of the interface 10 comprises a second sealing surface 66 configured to engage with a first sealing surface 64 of the exchangeable separation insert 6. During use of the modular centrifugal separator system 2, the second sealing surface 66 is configured to be stationary and engage with the rotating first sealing surface 64. The exchangeable tube kit 8 forms a separate unit which is at least partially insertable into the base unit 4. Since the second half 102 of the interface 10 is covered by the second sealing member portion 122, an inside of the tube kit 8 is protected from the ambient environment. Accordingly, provisions are made for handling the tube kit 8 as a sterile unit.

According to embodiments, the sealing member portion 122 may cover the second sealing surface 66. In this manner, the sealing member portion 122 may protect the second sealing surface 64.

After removal of the sealing member portion 122, when preparing the tube kit 8 for a separation operation, the second sealing surface 66 may engage with the corresponding first sealing surface 64 of the separation insert 6.

According to embodiments, the sealing member portion 122 may comprise a film member 122, an attachment portion 1221 of which is releasably connected to the second half 102 of the interface 10. In this manner, there may be provided a sealing member portion 122 configured for sealing the second half 102 of the interface 10 and for removal therefrom.

According to embodiments, the tube 22, 24, 26 for at least one of the liquid feed mixture, the heavy phase, and the light phase may be sealed at an end opposite to the second half 102 of the interface 10. Thus, the inside of the tube kit 8 may be protected.

The exchangeable tube kit 8 may comprise further features as discussed above with reference to FIGS. 1a-6.

Moreover, aspects and/or embodiments of the tube kit 8 may also apply to a further tube kit 50 provided as a separate unit. This so, by instead referencing the features related to the second half 102 of interface 10 and the sealing member portion 122 of the removable sealing member 12, to the second half 622 of the further interface 62 and the sealing member portion 902 of the further removable sealing member 90.

As mentioned above, an exchangeable separation insert 6 according to any one of aspects and/or embodiments discussed herein and at least one exchangeable tube kit 8 according to any one of aspects and/or embodiments discussed herein may be offered, provided, and/or delivered as a kit of parts.

FIG. 7 illustrates a method 200 for assembling of a modular centrifugal separator system 2 according to any one of aspects and/or embodiments discussed herein. Accordingly, reference is also made to FIGS. 1a-6.

The method 200 comprises steps of:
mounting 202 the exchangeable separation insert 6 in the rotatable member 52 of the base unit 4,
mounting 204 the exchangeable tube kit 8 in the base unit 4,
removing 206 the sealing member 12 from the first and/or second half/ves 101, 102 of the interface 10.

The steps of mounting 202 the separation insert 6 and mounting 204 the tube kit 8 in an order dictated by the layout of the base unit 4. The steps of mounting 202 the separation insert 6 and mounting 204 the tube kit 8 result in the separation insert 6 and the tube kit 8 being positioned in abutment with each other.

According to embodiments, the step of mounting 204 the exchangeable tube kit 8 in the base unit 4 may comprise a step of:
positioning 208 the first and second halves 102, 104 of the interface 10 in alignment with each other along the axial direction.

In such embodiments the step of mounting 204 the exchangeable tube kit 8 is preceded by the step of mounting 202 the separation insert 6.

According to embodiments, the method 200 may comprise steps of:
mounting 210 a further exchangeable tube kit 50 in the base unit 4, and
removing 212 the further sealing member 90 from the first and/or second half/ves 621, 622 of the further interface 62.

The step of mounting 210 the further exchangeable tube kit 50 may be performed from an axial end 88 of the rotor casing 52 of the exchangeable separation insert 6 opposite to an axial end 86 at which the tube kit 8 is mounted.

The steps of mounting 210 the further exchangeable tube kit 50 and removing 212 the further sealing member 90 may be performed after the step of mounting 202 the exchangeable separation insert 6.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A modular centrifugal separator system configured for separating a liquid feed mixture into a heavy phase and light phase, the modular centrifugal separator system comprising:
a base unit;
an exchangeable separation insert arranged in the base unit;
an exchangeable tube kit; and
an interface for fluid communication between the exchangeable separation insert and the exchangeable tube kit,
wherein the exchangeable separation insert comprises:
a rotor casing forming a separation space; and
a first half of the interface, the rotor casing being configured to rotate about a rotational axis extending in an axial direction,
wherein the exchangeable tube kit comprises:
at least one tube for one of the liquid feed mixture, the heavy phase, and the light phase, phase; and
a second half of the interface, and
wherein the modular centrifugal separator system comprises a removable sealing member covering the first and/or second half of the interface.

2. The modular centrifugal separator system according to claim 1, wherein the interface extends in a radial direction across the axial direction.

3. The modular centrifugal separator system according to claim 1, wherein the removable sealing member is accessible for removal from the interface from outside the base unit.

4. The modular centrifugal separator system according to claim 1, wherein the removable sealing member comprises a first sealing member portion covering the first half of the interface and a second sealing member portion covering the second half of the interface.

5. The modular centrifugal separator system according to claim 4, wherein the first sealing member portion comprises a first film member and the second sealing member portion comprises a second film member.

6. The modular centrifugal separator system according to claim 5, wherein the first film member comprises an attachment portion releasably connected to the first half of the interface, a folded portion connected to the attachment portion, and a grasping portion connected to the folded portion,
wherein the folded portion is connected to the attachment portion diametrically opposite to the grasping portion,
wherein at least a portion of the folded portion abuts against the attachment portion, and
wherein the grasping portion extends beyond the interface.

7. The modular centrifugal separator system according to claim 1, wherein the first half of the interface comprises a first sealing surface and the second half of the interface comprises a second sealing surface,
wherein the first and second sealing surfaces are configured to engage with each other when the removable sealing member has been removed, and
wherein, during use of the modular centrifugal separator system, the first sealing surface is rotatable about the rotational axis and the second sealing surface is stationary.

8. The modular centrifugal separator system according to claim 7, wherein a second sealing surface member comprising the second sealing surface is biased in a direction towards the first sealing surface, and
wherein the exchangeable tube kit comprises a restricting member configured for restricting a movement of the second sealing surface member in the axial direction.

9. The modular centrifugal separator system according to claim 8, wherein the first sealing surface is fixed in relation to the axial direction of the exchangeable separation insert.

10. The modular centrifugal separator system according to claim 1, comprising a securing member configured to establish an engagement between the exchangeable separation insert and the exchangeable tube kit, the engagement securing the exchangeable separation insert to the exchangeable tube kit for collective removal of the exchangeable separation insert and the exchangeable tube kit from the base unit.

11. The modular centrifugal separator system according to claim 7, wherein the securing member maintains the exchangeable separation insert and the exchangeable tube kit in a position in relation to each other such that the first and second sealing surfaces remain engaged with each other during the collective removal of the exchangeable separation insert and the exchangeable tube kit from the base unit.

12. The modular centrifugal separator system according to claim 1, wherein the exchangeable tube kit and the interface are arranged at a first axial end portion of the exchangeable separation insert,
wherein the modular centrifugal separator system comprises a further exchangeable tube kit and a further interface for fluid communication between the exchangeable separation insert and the further exchangeable tube kit,
wherein the further exchangeable tube kit and the further interface are arranged at a second axial end portion of the exchangeable separation insert,
wherein the exchangeable separation insert comprises a first half of the further interface,
wherein the further exchangeable tube kit comprises a tube for at least one of the liquid feed mixture, the heavy phase, and the light phase, and a second half of the further interface, and
wherein the modular centrifugal separator system comprises a removable further sealing member covering the first and/or second half of the further interface.

13. An exchangeable separation insert for a modular centrifugal separator system configured for separating a liquid feed mixture into a heavy phase and light phase and comprising the exchangeable separation insert, a base unit, an exchangeable tube kit, and an interface for fluid communication between the exchangeable separation insert and the exchangeable tube kit,
wherein the exchangeable separation insert comprises:
a rotor casing forming a separation space; and
a first half of the interface, the rotor casing being configured to rotate about a rotational axis extending in an axial direction,
wherein the exchangeable separation insert comprises a first sealing member portion of a removable sealing member, the first sealing member portion covering the first half of the interface, and
wherein the exchangeable separation insert forms a separate unit insertable into the base unit.

14. The exchangeable separation insert according to claim 13, wherein the first half of the interface comprises a first sealing surface, and
wherein the first sealing member portion covers the first sealing surface.

15. The exchangeable separation insert according to claim 13, comprising, with the exception of the first sealing member portion, only parts which are rotated about the rotational axis during use of the modular centrifugal separator system.

16. The exchangeable separation insert according to claim 13, wherein the first sealing member portion comprises a first film member, an attachment portion of the first film member being releasably connected to the first half of the interface.

17. An exchangeable tube kit for a modular centrifugal separator system configured for separating a liquid feed mixture into a heavy phase and light phase and comprising the exchangeable tube kit, a base unit, an exchangeable separation insert, and an interface for fluid communication between the exchangeable separation insert and the exchangeable tube kit, a first half gf the interface forming part of the exchangeable separation insert,
wherein the exchangeable tube kit comprises:
a tube for at least one of the liquid feed mixture, the heavy phase, and the light phase;
a second half of the interface; and
a sealing member portion of a removable sealing member covering the second half of the interface,
wherein the second half of the interface comprises a second sealing surface configured to engage with a first sealing surface of the exchangeable separation insert,
wherein, during use of the modular centrifugal separator system, the second sealing surface is configured to be stationary and engage with the rotating first sealing surface, and
wherein the exchangeable tube kit forms a separate unit at least partially insertable into the base unit.

18. The exchangeable tube kit according to claim 17, wherein the sealing member portion covers the second sealing surface.

19. The exchangeable tube kit according to claim 17, wherein the sealing member portion comprises a film member, an attachment portion of the film member being releasably connected to the second half of the interface.

20. A kit of parts comprising:
the exchangeable separation insert according to claim 13; and
at least one exchangeable tube kit, the at least one exchangeable tube kit comprising:
a tube for at least one of the liquid feed mixture, the heavy phase, and the light phase;
a second half of the interface; and
a sealing member portion of a removable sealing member covering the second half of the interface,
wherein the second half of the interface comprises a second sealing surface configured to engage with a first sealing surface of the exchangeable separation insert,
wherein, during use of the modular centrifugal separator system, the second sealing surface is configured to be stationary and engage with the rotating first sealing surface, and
wherein the exchangeable tube kit forms a separate unit at least partially insertable into the base unit.

21. A method for assembling the modular centrifugal separator system as defined in claim 1, comprising steps of:
mounting the exchangeable separation insert in the rotatable member of the base unit;
mounting the exchangeable tube kit in the base unit; and
removing the sealing member from the first and/or second half of the interface.
